(19) United States
(12) Patent Application Publication
(10) Pub. No.: US 2025/0217593 A1
(43) Pub. Date: Jul. 3, 2025

(54) Artificial Intelligence for Contextual Keyword Matching

(71) Applicant: 6SENSE INSIGHTS, INC., San Francisco, CA (US)

(72) Inventors: Ernest Kirubakaran Selvaraj, Bengaluru (IN); Akshay Rajendra Shah, Pune (IN); Rohit Kewalramani, Pune (IN); Samira Golsefid, Mountain View, CA (US)

(21) Appl. No.: 18/957,208

(22) Filed: Nov. 22, 2024

Related U.S. Application Data
(60) Provisional application No. 63/617,265, filed on Jan. 3, 2024.

(51) Int. Cl. G06F 40/289; G06F 40/284; G06N 3/0455

(52) U.S. Cl. CPC G06F 40/289; G06F 40/284; G06N 3/0455

(57) ABSTRACT

State-of-the-art keyword matching may result in a high number of false positives, since computers are unable to understand context in the same manner as humans. Accordingly, artificial intelligence for contextual keyword matching is disclosed. In particular, the artificial intelligence may comprise an encoder that comprises one or more phrase-localized attention layers, with keyword-level positional encoding to ensure permutation invariance. Each phrase-localized attention layer may comprise a multi-head phrase-localized attention network for each keyword in an input keyword array. The encoder may also comprise one or more scaled dot-product attention layers, subsequent to the phrase-localized attention layer(s). The phrase-localized attention layer(s) enable the encoder to learn the local structure of the keywords, while the scaled dot-product attention layers enable the encoder to learn the relationships between the keywords. This improves the accuracy of the contextual keyword matching, which may, in turn, improve the accuracy of downstream functions.

### CROSS-REFERENCE TO RELATED APPLICATIONS

This application claims priority to U.S. Provisional Patent App. No. 63/617,265, filed on Jan. 3, 2024, which is hereby incorporated herein by reference as if set forth in full.

### BACKGROUND

### Field of the Invention

The embodiments described herein are generally directed to artificial intelligence, and, more particularly, to artificial intelligence for contextual keyword matching.

### Description of the Related Art

Keyword matching has a multitude of applications, including in the marketing industry. Traditional string matching is insufficient for modern applications, since it produces a lot of false positives. For example, the word “apple” is both a business keyword for the company, Apple Inc., and the name of a fruit. Thus, traditional string matching, in the context of business, will return results for the fruit, despite being irrelevant to the business. To avoid such false positives, effective keyword matching must be aware of the context.

### SUMMARY

Accordingly, systems, methods, and non-transitory computer-readable media are disclosed for artificial intelligence for contextual keyword matching.

In an embodiment, a method comprises using at least one hardware processor to: receive a user keyword array and a plurality of activity keyword arrays, wherein each of the user keyword array and the plurality of activity keyword arrays comprises a plurality of keywords, wherein each keyword comprise one or a plurality of tokens, and wherein each of the plurality of activity keyword arrays is associated with an activity record comprising a Uniform Resource Locator (URL) and an Internet Protocol (IP) address; apply an encoder to the user keyword array to produce a user embedding vector, wherein the encoder comprises one or more phrase-localized attention layers, and wherein each of the one or more phrase-localized attention layers comprises one phrase-localized attention network for each of the plurality of keywords in the user keyword array; for each of the plurality of activity keyword arrays, apply the encoder to the activity keyword array to produce an activity embedding vector, wherein each of the one or more phrase-localized attention layers comprises one phrase-localized attention network for each of the plurality of keywords in the activity keyword array, calculate a similarity metric between the user embedding vector and the activity embedding vector, and when the similarity metric indicates a match between the user embedding vector and the activity embedding vector, add the activity record that is associated with the activity embedding vector to a relevant set of activity records; and output the relevant set of activity records to one or more downstream functions.

The one or more phrase-localized attention layers may be at least three phrase-localized attention layers. The one or more phrase-localized attention layers may consist of three phrase-localized attention layers. The encoder may further comprise one or more scaled dot-product attention layers. The one or more scaled dot-product attention layers may be subsequent to the one or more phrase-localized attention layers. The one or more scaled dot-product attention layers may be at least three scaled dot-product attention layers. The one or more scaled dot-product attention layers may consist of three scaled dot-product attention layers.

The encoder may comprise at least three phrase-localized attention layers, followed by at least three scaled dot-product attention layers. Each phrase-localized attention network and each of the at least three scaled dot-product attention layers may utilize multi-head attention. The encoder may utilize keyword-level positional encoding to encode a position of each token within each of the plurality of keywords. Each phrase-localized attention network may utilize multi-head attention. The encoder may utilize keyword-level positional encoding to encode a position of each token within each of the plurality of keywords. The encoder may consist of three phrase-localized attention layers, followed by three scaled dot-product attention layers.

The method may further comprise using the at least one hardware processor to, prior to applying the encoder, train a transformer network comprising the encoder and a decoder, wherein the encoder receives a keyword array from a training dataset as an input and outputs an embedding vector, and wherein the decoder receives the embedding vector, output by the encoder, as an input and outputs a predicted keyword. The method may further comprise using the at least one hardware processor to, prior to training the transformer network, generate the training dataset by: receiving a plurality of keyword arrays; and for each of the plurality of keyword arrays, for each of one or more iterations, selecting one keyword from the keyword array, generating an input consisting of all keywords in the keyword array except for selected keyword, labeling the input with a target consisting of the selected keyword, and adding the labeled input to the training dataset. Training the transformer network may comprise, for each of at least a subset of the labeled inputs in the training dataset: applying the transformer network to the input in the labeled input to produce the predicted keyword for the input; computing a loss between the target, with which the input is labeled, and the predicted keyword; and updating the transformer network to minimize the computed loss.

The similarity metric may comprise a cosine similarity between the user embedding vector and the activity embedding vector. The one or more downstream functions may comprise a predictive model that predicts a buying intent of at least one company, associated with at least one IP address in the relevant set of activity records, based on the relevant set of activity records.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates a data flow in which contextual keyword matching may be utilized, according to an embodiment;

FIG. 4 illustrates the difference between two different positional encodings, according to an example;

FIG. 5 illustrates the attention mechanism in a standard transformer, according to an example;

FIG. 6 illustrates an attention mechanism, comprising a phrase-localized attention layer, according to an embodiment;

FIG. 7 illustrates an encoder with phrase-localized attention layers, according to an embodiment;

FIG. 8 illustrates a data flow for training an encoder, according to an embodiment;

FIG. 9 illustrates a data flow for operating an encoder, according to an embodiment; and

FIG. 10 illustrates a process for contextual keyword matching, according to an embodiment.

### DETAILED DESCRIPTION

In an embodiment, systems, methods, and non-transitory computer-readable media are disclosed for artificial intelligence for contextual keyword matching. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

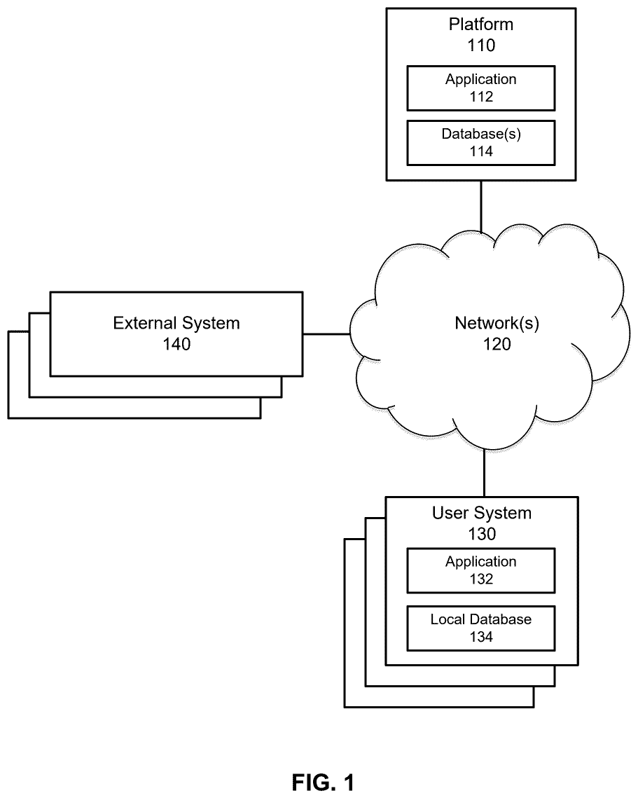

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that user system 130 would be the personal computer or workstation of an agent of an organization, such as a business that sells one or more products (e.g., goods or services) to other businesses. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including, without limitation, MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. These data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

### 2. Example Processing System

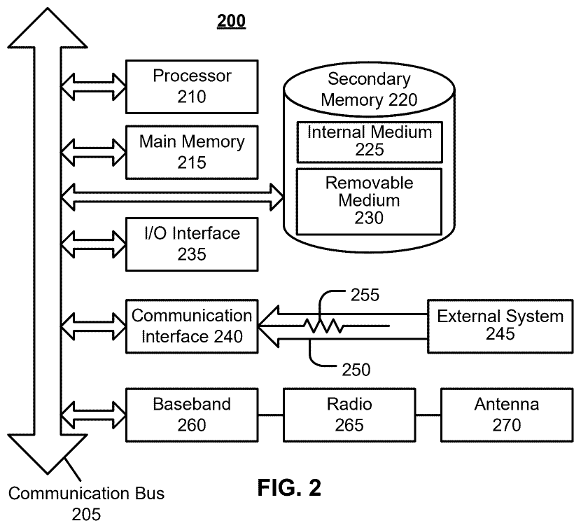

FIG. 2 illustrates an example processing system 200, by which one or more of the processes described herein may be executed, according to an embodiment. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive or card, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, may enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

### 3. Example Process

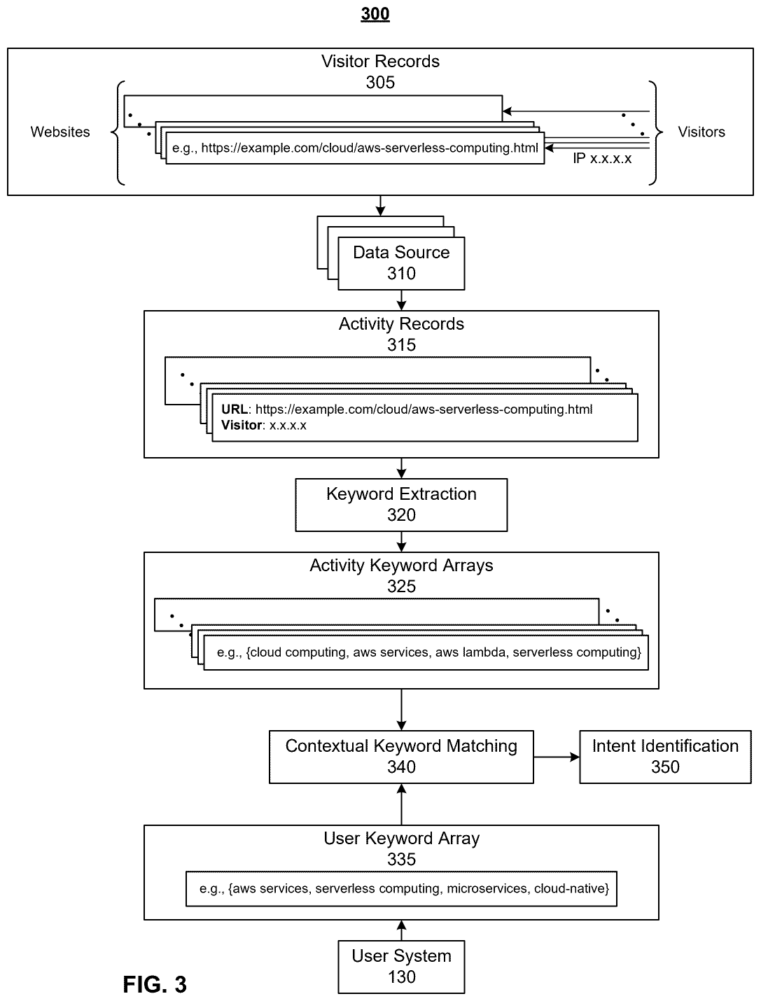

FIG. 3 illustrates a data flow 300 in which contextual keyword matching may be utilized, according to an embodiment. It is contemplated that the various components of data flow 300 would be implemented in software, for example, as one or more software modules. However, in an alternative embodiment, one or more of the components may be implemented as hardware, or as a combination of software and hardware.

Initially, visitor records 305 may be collected by one or more data sources 310. A visitor records 305 may be generated whenever a visitor visits a website. It is generally contemplated that the websites would be third-party websites (e.g., hosted on one or more external systems 140), but the websites could alternatively or additionally include websites operated by a user of platform 110 or by platform 110 itself (e.g., hosted on platform 110). Each visitor record 305 may comprise the Uniform Resource Locator (URL) of the online resource that was visited, and the Internet Protocol (IP) address of the system that requested the online resource. It should be understood that each visitor record 305 may also comprise additional information, such as a timestamp (e.g., representing Unix time) representing the day and time at which the online resource was requested, a domain associated with the IP address, and/or the like.

One or a plurality of data sources 310 may collect visitor records 305. Each data source 310 may be an external system 140 that aggregates visitor records 305 for one or a plurality of websites. For example, each data source 310 may aggregate visitor records 305 and transmit activity records 315, representing visitor records 305, to server application 112, via network(s) 120. Activity records 315 may be pushed by an external system 140, representing a data source 310, to server application 112 through an application programming interface of server application 112. Alternatively, activity records 315 may be pulled by server application 112 from an external system 140, representing a data source 310, through an application programming interface of external system 140. In either case, activity records 315 may transmitted to server application 112 in real time as the visitor records 305 are obtained, periodically (e.g., hourly, daily, weekly, etc.) in batches, and/or in response to any other triggering event (receipt of a user operation, the number of activity records 315 reaching a predefined threshold, etc.). In an alternative or additional embodiment, at least one data source 310 may comprise database 114 or another internal component of platform 110, from which activity records 315 can be retrieved by server application 112.

Data source 310 may generate an activity record 315 for each visitor record 305. Each activity record 315 may comprise the URL of the online resource that was visited, and the IP address that requested the online resource. Each activity record 315 may also comprise additional information, such as a timestamp representing the day and time at which the online resource was requested, a domain associated with the IP address, and/or the like. In an embodiment, activity record 315 may be identical to visitor record 305, in which case visitor records 305 and activity records 315 are one in the same. In an alternative embodiment, each data source 310 formats each visitor record 305 into an activity record 315 in a common format. In this case, each data source 310 may also perform other pre-processing, such as normalizing and cleaning each visitor record 305 to produce a corresponding activity record 315.

Server application 112 may comprise a keyword-extraction module 320 that generates an activity keyword array 325 from each activity record 315. In particular, keyword-extraction module 320 may automatically generate an activity keyword array 325 that comprises one or more keywords extracted from the online resource, such as keyword(s) from the content of the online resource, keyword(s) from the metadata of the online resource (e.g., title, description, explicit keywords, etc.), keyword(s) from the URL of the online resource (e.g., subdomain, component of the path, component of the query string, fragment, etc.), keyword(s) extracted by machine learning (e.g., Watson Natural Language Understanding), and/or the like. Each activity keyword array 325 may comprise or consist of a list of keywords, represented in any suitable data structure. A keyword may be any character string, and may represent a single word, a plurality of words, a phrase, an acronym, a number, or any other textual data.

It is generally contemplated that keyword-extraction module 320 would be implemented in server application 112. However, alternatively, keyword-extraction module 320 may be implemented by one or more data sources 310. In this case, data source 310 may transmit activity keyword arrays 325 to server application 112, instead of or in addition to activity records 315. In an embodiment, one or more data sources 310 may transmit activity records 315 to server application 112, while another one or more data sources 310 may implement keyword-extraction module 320 and transmit activity keyword arrays 325.

As discussed above, an activity record 315 may be generated for each visitor record 305, and an activity keyword array 325 may be generated for each activity record 315. Given that a website may have thousands or millions of visits a day to a single URL and that visitor records 305 may be collected for tens, hundreds, or thousands or more URLs of thousands or millions of websites, there may easily be millions, if not billions, and potentially trillions, of visitor records 305. Accordingly, it is contemplated that millions, billions, and potentially trillions, of activity keyword arrays 325 may be generated. In addition, each activity keyword array 325 may comprise tens, hundreds, thousands, or more of keywords.

In addition, a user system 130 may submit a user keyword array 335 to server application 112. U User keyword array 335 may comprise a list of keywords, represented in any suitable data structure. The list of keywords in user keyword array 335 may comprise keywords that are representative of the user's business, and may be derived by or for the user in any suitable manner. U.S. Patent Publication No. 2021/0406685, published on Dec. 30, 2021, which is hereby incorporated herein by reference as if set forth in full, describes a suitable method for quickly generating a list of keywords. Again, a keyword may be any character string, and may represent a single word, a plurality of words, a phrase, an acronym, a number, or any other textual data, and user keyword array 335 may comprise tens, hundreds, thousands, or more of keywords.

In general, the keywords in user keyword array 335 will overlap with the keywords in one or more, and typically a plurality of, activity keyword arrays 325. However, simply because a keyword in user keyword array 335 is identical to a keyword in an activity keyword array 325 does not mean that the keywords match, as the keyword may have different meanings within different contexts. For example, the keyword “cloud,” in the context of computing, refers to the on-demand availability of computing resources, whereas the keyword “cloud,” in the context of meteorology, refers to a visible collection of water droplets or ice particles in the atmosphere.

Server application 112 may comprise a contextual-keyword-matching module 340 that receives the activity keyword arrays 325 and user keyword array 335 as input. Contextual-keyword-matching module 340 may match user keyword array 335 to activity keyword arrays 325 using contextual matching. In contextual matching, two keyword arrays match when they represent the same or similar contexts. Notably, this means that two keyword arrays do not have to overlap (i.e., have one or more shared keywords) in order to match each other; although, this may often be the case. Rather, two different keyword arrays may match even when they do not have any overlap (i.e., no shared keywords). An activity keyword array 325 that contextually matches user keyword array 335 may be referred to herein as a “matching activity keyword array.”

Each activity keyword array 325 is associated with an activity record 315, from which it is derived. As a result, each activity keyword array 325, including each matching activity keyword array 325, is associated with the URL and IP address and preferably a timestamp in the corresponding activity record 315. In an embodiment, the activity record 315 (which may refer to any representation of the associated URL, IP address, and/or timestamp) that is associated with each matching activity keyword array 325 may be provided as an input to an intent-identification module 350 and/or one or more other downstream functions. These activity records 315 represent behavioral information for companies, and particularly representatives of those companies, derived from their online activities (e.g., visits to third-party websites). It should be understood that these companies may represent potential customers of one or more products offered by a user of platform 110.

Server application 112 may comprise an intent-identification module 350 that may, for each activity record 315 that is provided by contextual-keyword-matching module 340 (e.g., comprising a URL, IP address, and/or timestamp), identify a company that is associated with the IP address in the activity record 315. For example, U.S. Pat. No. 10,536,327, issued on Jan. 14, 2020, which is hereby incorporated herein by reference as if set forth in full, describes suitable methods for identifying companies by IP addresses. In addition, intent-identification module 350 may input the activity records 315, associated with each identified company, into a predictive model that predicts a buying intent of the company, based on the number of visits represented by the activity records 315 associated with that company, weightings associated with different URLs in the activity records 315 associated with that company, and/or the like. For example, U.S. Pat. No. 9,202,227, issued on Dec. 1, 2015, which is hereby incorporated herein by reference as if set forth in full, describes a suitable prediction model for predicting buying intent. It should be understood that a visit, by a company, to a URL, whose activity keyword array 325 (e.g., representing a topic of the URL) has the same or similar context as user keyword array 325 (e.g., representing the user's business), is an online activity that may be relevant to the company's buying intent for a product offered by the user's business.

The user may utilize the predicted buying intent, produced by intent-identification module 350 for one or more companies, to make marketing decisions. For example, the buying intent may comprise an intent score for each company. Notably, since the input records represent visits to online resources that contextually match the user's domain (e.g., relevant to a category of product that the user sells), the intent score for a company represents the company's interest in the user's domain (e.g., the company's interest in the user's category of product). For instance, a visit to the example URL, “example.com/cloud/aws-serverless-computing.html,” indicates buying intent for serverless computing. When the intent score for a company satisfies (e.g., is greater than or equal to) a threshold value or spikes at a threshold rate, it may be inferred that the company is likely to be making a purchase decision soon for a category of product sold by the user. Thus, the user may be alerted. Based on this alert, the user may contact the company (e.g., call, email, or otherwise contact a representative of the company) or otherwise engage with the company (e.g., purchase advertising targeted at the company). U.S. Patent Publication No. 2021/0406933, published on Dec. 30, 2021, which is hereby incorporated herein by reference as if set forth in full, describes a suitable method for automatically recommending marketing actions to be taken and identifying relevant contacts at a company.

It is generally contemplated that disclosed embodiments would be used for business-to-business (B2B) users. B2B users represent businesses that sell products (e.g., goods or services) to other businesses. However, it should be understood that disclosed embodiments may be applied to other types of engagements and used in other applications. More generally, the disclosed embodiments of contextual keyword matching, as exemplified by contextual-keyword-matching module 340, may be applied to any type of keyword matching in which two keyword arrays are compared.

### 4. Contextual Keyword Matching

Embodiments of processes for contextual keyword matching will now be described in detail. It should be understood that these processes may be implemented by contextual-keyword-matching module 340 of server application 112. As discussed elsewhere herein, the input to contextual-keyword-matching module 340 may comprise a plurality of activity keyword arrays 325 and a user keyword array 335, and the output of contextual-keyword-matching module 340 may comprise an activity record 315 corresponding to each activity keyword array 325 that contextual-keyword-matching module 340 determines matches user keyword array 335. An activity keyword array 325 may match user keyword array 335 when they have the same or similar contexts.

### 4.1 Positional Encoding

The transformer was first introduced in “Attention Is All You Need,” by Ashish Vaswani et al., arXiv:1706.03762 (2017), which is hereby incorporated by reference as if set forth in full. A transformer uses a deep-learning architecture to convert text into tokens, which are each converted into an embedding vector. At each layer of the deep-learning architecture, each token is contextualized with other tokens, within the scope of the context window, via a parallel multi-head attention mechanism. The multi-head attention mechanism allows the signal for important tokens to be amplified, while the signal for less important tokens is diminished. However, the standard transformer is not permutation-invariant. In other words, the result depends on the specific order of the tokens in the text. Thus, the standard transformer is not suitable for keyword arrays, which have no natural ordering.

Permutation invariance means that the output of the transformer is the same regardless of the order of the tokens that are input into the transformer. For example, if a keyword array consists of N keywords, the output of the transformer should be the same for all N! orderings of those keywords. Permutation invariance is rare in natural language processing (NLP), since few NLP tasks take an unordered set of keywords as an input.

A permutation-invariant transformer was introduced in “Permutation Invariant Strategy Using Transformer Encoders for Table Understanding,” by Sarthak Dash et al., Findings of the Association for Computational Linguistics: NAACL 2022, pp. 788-800, Jul. 10-15, 2022, which is hereby incorporated herein by reference as if set forth in full. This modified transformer achieves permutation invariance by modifying the standard positional encoding of the transformer.

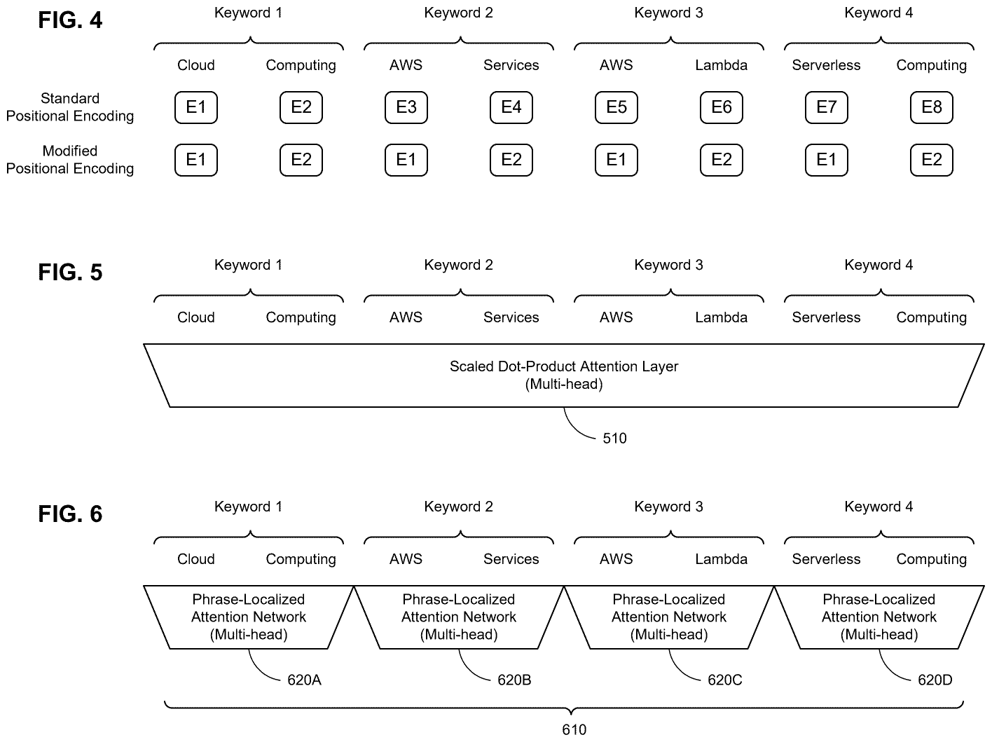

FIG. 4 illustrates the difference between the positional encodings of the standard transformer in Vaswani et al. and the positional encodings of the modified transformer in Dash et al. The vector of positional encodings for the standard transformer simply represent the order of the tokens from the first keyword to the N-th keyword. In contrast, the positional encodings for the modified transformer are reset after each keyword. In this example, each keyword consists of two tokens. Thus, each keyword in the modified transformer is represented by a positional encoding of E1 for the first token and E2 for the second token. In this manner, every keyword will have the same positional encoding, irrespective of the order in which the keywords are input to the transformer.

Although it achieves permutation invariance, there is a flaw in the modified transformer of Dash et al. As seen in this example, each of the tokens “Cloud,” “AWS,” “AWS,” and “Serverless” has a position of E1, and each of the tokens “Computing,” “Services,” “Lambda,” and “Computing” has a position of E2. As a result, the modified transformer cannot distinguish which token at position E1 comes before each token at position E2. For example, the modified transformer cannot distinguish whether “Cloud” comes before “Computing,” “Services,” “Lambda,” or “Computing.” Consequently, the modified transformer does not know the correct arrangement and relationships of tokens within their respective keywords.

### 4.2. Phrase-Localized Attention Layer

In an embodiment, to solve the flaw caused by the positional encodings of the modified transformer, a phrase-localized attention layer is added to the modified transformer of Dash et al. In other words, the transformer of disclosed embodiments may comprise the positional encodings in the modified transformer of Dash et al., in combination with at least one phrase-localized attention layer.

FIG. 5 illustrates the attention mechanism in the standard transformer of Vaswani et al., according to an example. In the standard transformer, the attention mechanism comprises a scaled dot-product attention layer 510 applied across the entire text (i.e., all of the tokens in the text). Scaled dot-product attention layer 510 enables the transformer to weigh the importance of different tokens in the text dynamically. The key components of scaled dot-product attention layer 510 are queries (Q), which represent the current position (i.e., representing a token according to its positional encoding) for which the transformer seeks information, keys (K), which represent the positions (i.e., representing tokens according to their positional encodings) to which the queries may pay attention, and values (V), which contain the content associated with each key. Scaled dot-product attention, as implemented by scaled dot-product attention layer 510, computes attention scores by calculating the dot product between the current query vector and each key vector to determine the relevance and then scaling the attention scores (e.g., by the square root of the dimensionality of the key vectors) to prevent the dot products from growing too large, applies a Softmax function to convert the attention scores into probabilities, which ensures that the attention weights sum to one and highlight the most relevant keys, and computes the weight sum of values by multiplying each value vector by its corresponding attention weight to obtain the final output. Scaled dot-product attention may utilize multiple attention heads to capture different types of relationships and interactions within the text. Each head may perform scaled dot-product attention independently, and their outputs may be concatenated and linearly transformed.

FIG. 6 illustrates an attention mechanism, comprising a phrase-localized attention layer 610, according to an embodiment. Phrase-localized attention layer 610 comprises a plurality of phrase-localized attention networks 620, illustrated as phrase-localized attention networks 620A, 620B, 620C, and 620D (i.e., for each of four keywords). Phrase-localized attention layer 610 comprises a phrase-localized attention network 620 for each keyword. Each phrase-localized attention network 620 may apply scaled dot-product attention, just as in scaled dot-product attention layer 510, but to each individual keyword, instead of the entire text (i.e., the entire keyword array). Just like scaled dot-product attention layer 510, each phrase-localized attention network 620 may utilize multiple attention heads. All of the phrase-localized attention networks 620 in a given phrase-localized attention layer 610 may be identical to each other. Advantageously, in contrast to the modified transformer of Dash et al., phrase-localized attention layer 610 enables the transformer to learn the structure of individual keywords.

Consider a keyword array (e.g., activity keyword array 325 or user keyword array 335) having N keywords. The output matrix of phrase-localized attention layer 610 may be given by:

$$( \begin{matrix}{X}_{1} & 0 & 0 & 0 \\ 0 & {X}_{2} & 0 & 0 \\ 0 & 0 & ⋱ & 0 \\ 0 & 0 & 0 & {X}_{N}\end{matrix} )$$

$${X}_{i} = Attention ( {Q}_{i} , {K}_{i} , {V}_{i} ) , ∀ i ∈ \{ 1 , 2 , … , N \}$$

$$Attention ( {Q}_{i} , {K}_{i} , {V}_{i} ) = softmax ( \frac{{Q}_{i} , {K}_{i}^{T}}{\sqrt{{d}_{ki}}} ) {V}_{i}$$

wherein Qᵢ, Kᵢ, and Vᵢ represent the query, key, and value matrices, respectively, for the i-th keyword in the keyword array, dₖᵢ represents the dimension of the query and key vectors, and T represents the transpose of the respective matrix.

### 4.3 Encoder

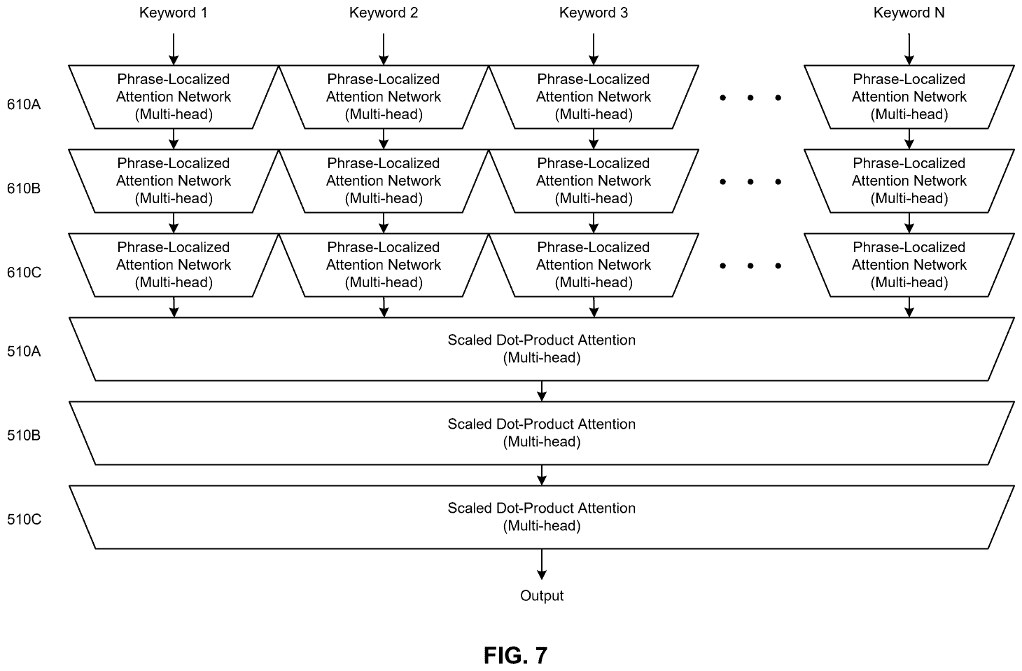

FIG. 7 illustrates an encoder 700 with phrase-localized attention layers 610, according to an embodiment. In this embodiment, the first three layers of encoder 700 are phrase-localized attention layers 610, illustrated as phrase-localized attention layers 610A, 610B, and 610C. In contrast, the second three layers of encoder 700 are scaled dot-product attention layers 510, illustrated as scaled dot-product attention layers 510A, 510B, and 510C. More generally, encoder 700 may comprise one or more phrase-localized attention layers 610 in the initial layer(s) of encoder 700 and one more scaled dot-product attention layers 510 in the subsequent layer(s) of encoder 700. Advantageously, this enables encoder 700 to learn the local structure of the keywords in the initial layer(s) (i.e., via phrase-localized attention layer(s) 610) and learn about the relationships between keywords in the subsequent layer(s) (i.e., via scaled dot-product attention layer(s) 610). In an embodiment, encoder 700 comprises at least three phrase-localized attention layers 610 and/or at least three scaled dot-product attention layers 510 that are subsequent to the phrase-localized attention layer(s) 610. In addition, encoder 700 retains permutation invariance by utilizing keyword-level positional encoding (i.e., the positional encodings are reset for each keyword) to encode a position of each token within each of the plurality of keywords. Advantageously, a encoder 700, configured in this manner, with phrase-localized attention layer(s) 610 and keyword-level positional encoding, improves the accuracy of the output for downstream function(s), such as intent-identification module 350. Each phrase-localized attention network 620 in each phrase-localized attention layer 610, as well as each scaled dot-product attention layer 510, may utilize multi-head attention.

Advantageously, encoder 700, with phrase-localized attention layer(s) 610 and keyword-level positional encoding, improves the artificial intelligence for contextual keyword matching. In particular, such an encoder 700 enables a computer to understand context, which, in turn, enables the computer to understand words that may have substantially different meanings in different context (e.g., brand names or trademarks, computing terms, etc.). In other words, encoder 700 enables the computer to mimic the judgment of a human, without requiring a human. This avoids a lot of false positives that are prevalent in state-of-the-art keyword matching.

### 4.4 Training of Encoder

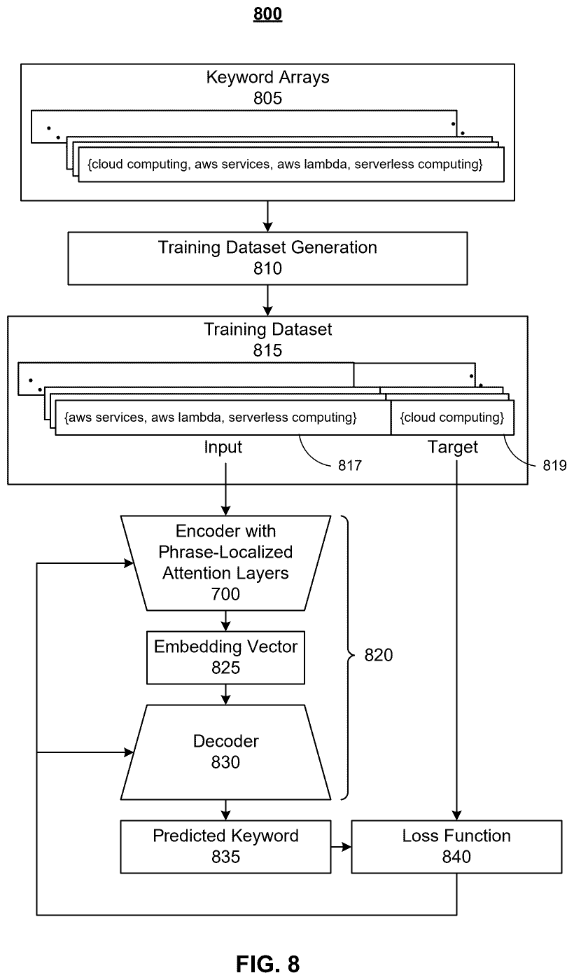

FIG. 8 illustrates a data flow 800 for training encoder 700, according to an embodiment. The goal of data flow 800 is to train encoder 700 to, given an input keyword array (e.g., activity keyword array 325 or user keyword array 335), output an embedding vector that captures the context of the input keyword array. To achieve this, the transformer network is modified to utilize the keyword-level positional encoding of the modified form of the transformer, described in Dash et al. In particular, the positional encoding encodes the position of each token in each keyword, independently of the tokens in the other keywords, starting from position E1 and incrementing the position for each token up through the last token in the keyword. In addition, encoder 700 may comprise one or more (e.g., at least three) phrase-localized attention layers 610, followed by one or more (e.g., at least three) scaled dot-product attention layers 510.

Server application 112 may comprise a training-dataset-generation module 810 that generates a training dataset 815 from a plurality of keyword arrays 805. Keyword arrays 805 may comprise historical, user-created, and/or synthetically generated arrays of keywords, which are identical in structure to activity keyword arrays 325 and user keyword arrays 335. Keyword arrays 805 may comprise millions, billions, and potentially trillions, of keyword arrays, and each keyword array 805 may comprise tens, hundreds, thousands, or more of keywords.

To generate training dataset 815, training-dataset-generation module 810 may, for each of the plurality of keyword arrays 805, select one of the keywords to be a target 819 and retain the other keywords as an input 817. In other words, if a keyword array 805 consists of N keywords, input 817 will consist of N−1 keywords, and target will consist of 1 keyword. Thus, training dataset comprises, for each of the plurality of keyword arrays 805, an input 817 consisting of a keyword subarray of the keyword array 805, and a target 819 consisting of the single keyword from keyword array 805 that was not included in input 817. This combination of input 817 and target 819 may be referred to herein as a “labeled input.” In particular, training dataset 815 may be generated, by training-dataset-generation module 810, by receiving a plurality of keyword arrays 805, and for each of the plurality of keywords arrays 805, for each of one or a plurality of iterations, selecting one keyword from the keyword array 805, generating input 817 consisting of all keywords in the keyword array 805 except for the selected keyword, labeling input 817 with a target 819 consisting of the selected keyword, and adding the labeled input to training dataset 815. Target 819 may be randomly selected from each keyword array 805 and/or in any other suitable manner.

In an embodiment, more than one labeled input may be generated from a single keyword array 805 by selecting a different target 819 for each labeled input in a plurality of iterations for each keyword array 805. In this case, each keyword in keyword array 805 may be selected as target 819 exactly once. Thus, training dataset 815 may have substantially more records than are in keyword arrays 805.

During training, a transformer network 820, comprising encoder 700 and a decoder 830, is trained as a whole. At a high level, encoder 700 receives a keyword array from training dataset 815 as an input and outputs an embedding vector. Then, decoder 830 receives the embedding vector, output by encoder 700, as an input and outputs a predicted keyword. During training, for each of at least a subset of the labeled inputs in training dataset 815, transformer network 820 is applied to input 817 in the labeled input to produce a predicted keyword for the input, a loss is computed between the target, with which input 817 is labeled, and the predicted keyword, and transformer network 820 is updated to minimize the computed loss.

In particular, each input 817 is input to transformation network 820, comprising encoder 700, with phrase-localized attention layer(s) 610 and keyword-level positional encoding. Encoder 700 extracts a plurality of features from input 817. These features, which represent a context of input 817, are output by encoder 700 as an embedding vector 825. Subsequently, decoder 830 decodes this embedding vector 825, output by encoder 700 and representing the context of input 817, into a predicted keyword 835, which is output to loss function 840. Essentially, if encoder 700 encodes input 817 correctly (i.e., properly captures the context of input 817 in embedding vector 825), then decoder 830 should be able to correctly predict target 819 (i.e., the missing keyword). For instance, using the illustrated example, if an input 817 of {AWS services, AWS lambda, serverless computing} is provided to encoder 700, trained decoder 830 should be able to predict “cloud computing” as predicted keyword 835.

Loss function 840 receives predicted keyword 835 and target 819, for a given input 817, and computes an error or loss between predicted keyword 835 and target 819. Any suitable loss function 840 may be used, such as cross-entropy loss, mean squared error, or the like. The goal of the training is to minimize the loss computed by loss function 840. In particular, the weights in encoder 700 and decoder 830 may be updated, using backpropagation, based on the loss computed by loss function 840. After a large number of training iterations (e.g., millions or billions of labeled inputs) and a sufficient number of epochs, transformer network 820 should be well-trained.

In an embodiment, label smoothing, as described in Vaswani et al., is used during training of transformer network 820. Label smoothing is a regularization technique that involves adjusting targets 819, during training, to prevent transformer network 820 from becoming overconfident about its predictions (i.e., predicted keywords 835). By preventing transformer network 820 from becoming overconfident and encouraging transformer network 820 to consider alternatives, label smoothing contributes to better generalization, improved calibration, and resilience against noisy data.

### 4.5 Operation of Encoder

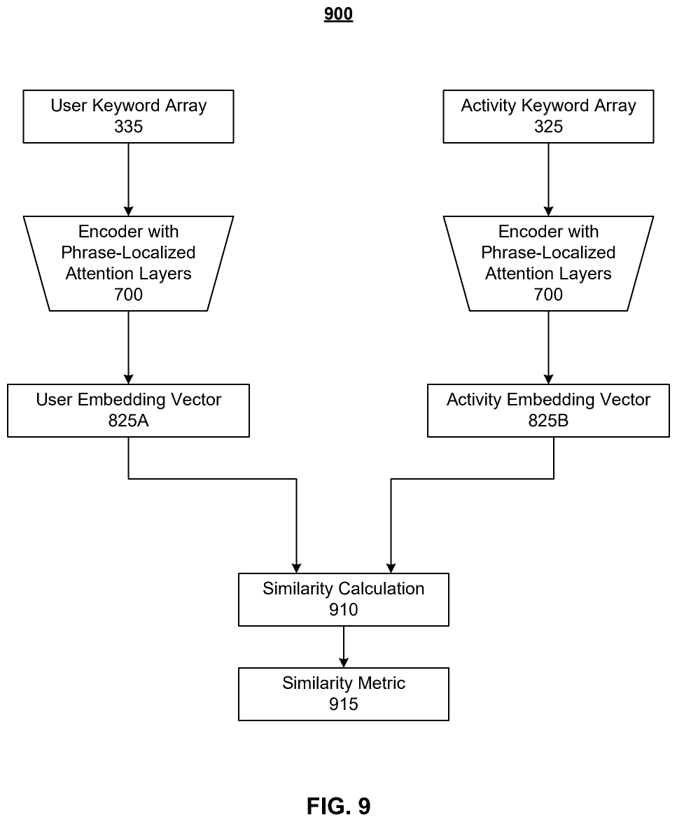

FIG. 9 illustrates a data flow 900 for operating encoder 700, according to an embodiment. It is contemplated that the various components of data flow 900 would be implemented in software, for example, as one or more software modules. However, in an alternative embodiment, one or more of the components may be implemented as hardware, or as a combination of software and hardware.

In an embodiment, decoder 830 is discarded after transformer network 820 has been trained. The encoder 700, remaining from transformer network 820, is used to generated embedding vectors 825 that represent the context of keyword arrays, during operation of contextual-keyword-matching module 340. In particular, contextual-keyword-matching module 340 may implement data flow 900 to, for each activity keyword array 325, determine whether or not user keyword array 335 matches that activity keyword array 325.

Encoder 700 is used to determine the contexts of user keyword array 335 and each activity keyword array 325. For each keyword array that is input, encoder 700 will segment the keyword array into tokens, and encode the tokens with keyword-level positions (i.e., reset to position E1 at the start of each keyword). The set of token(s) for each keyword in each keyword array is then passed through a phrase-localized attention network 620 in one or more (e.g., three or more) phrase-localized attention layers 610 (e.g., 610A-610B). Next, all of the tokens in all of the keywords in the entire keyword array may be passed through one or more (e.g., three or more) scaled dot-product attention layers 510 (e.g., 510A-510C). The output of encoder 700 comprises an embedding vector 825 for the keyword array that was input to encoder 700. For example, encoder 700 may output user embedding vector 825A for user keyword array 335, and output an activity embedding vector 825B for each activity keyword array 325. Each embedding vector 825 may comprise a set of numerical values (e.g., real numbers), representing the contextual features of the input keyword array.

It should be understood that different keyword arrays may contain a different number of keywords. Thus, if a keyword array comprises N keywords, phrase-localized attention network 620 may be replicated N times, to produce a phrase-localized attention layer 610 that consists of N identical phrase-localized attention networks 620, such that every keyword has an independent phrase-localized attention network 620 that processes the respective keyword using a keyword-level positional encoding. While the phrase-localized attention network 620 in each phrase-localized attention layer 610 may be identical, the phrase-localized attention network 620 in one phrase-localized attention layer 610 (e.g., 610A) may be different (e.g., comprising different weights) than the phrase-localized attention network 620 in another phrase-localized attention layer 610 (e.g., 610B and/or 610C).

User embedding vector 825A, output by encoder 700 for user keyword array 335, is paired with the activity embedding vector 825B for each activity keyword array 325. Each pairing of user embedding vector 825A with one of activity user embeddings 825B is input to a similarity-calculation module 910. In particular, contextual-keyword-matching module 340 may comprise similarity-calculation module 910, which calculates the similarity between user embedding vector 825A and activity embedding vector 825B, and outputs a similarity metric 915.

Similarity metric 915 may comprise a numerical value that represents how similar user embedding vector 825A is to activity embedding vector 825B. In an embodiment, similarity-calculation module 930 calculates similarity metric 915 based on a distance between user embedding vector 825A and activity embedding vector 825B. This distance may be a Euclidean distance, Manhattan distance, Minkowski distance, Chebyshev distance, cosine distance, Hamming distance, Jaccard distance, Mahalanobis distance, Canberra distance, Bray-Curtis distance, Wasserstein distance, Pearson correlation distance, Hellinger distance, or any other suitable measure of distance between two vectors. Similarity metric 915 may comprise or consist of the value of this distance, the value of this distance normalized to a fixed numerical range (e.g., 0.0 to 1.0, 0 to 100, etc.), or any other value derived from this distance. In an embodiment, similarity metric 915 is calculated from the distance such that a higher similarity metric 915 represents greater contextual similarity than a lower similarity metric 915. In other words, similarity metric 915 may be calculated as an inverse of the distance (e.g., one minus the distance, normalized to a scale of 0.0 to 1.0), such that shorter distances produce higher similarity metrics 915, and longer distances produce lower similarity metrics 915. In a preferred embodiment, similarity metric comprises or consists of the cosine similarity between user embedding vector 825A and activity embedding vector 825B.

Similarity metric 915 represents how close user embedding vector 825A, which represents the context of user keyword array 335, is to activity embedding vector 825B, which represents the context of a given activity keyword array 325. Thus, similarity metric 915 represents the contextual similarity between user keyword array 335 and the given activity keyword array 325.

### 4.6 Operation of Contextual Keyword Matching

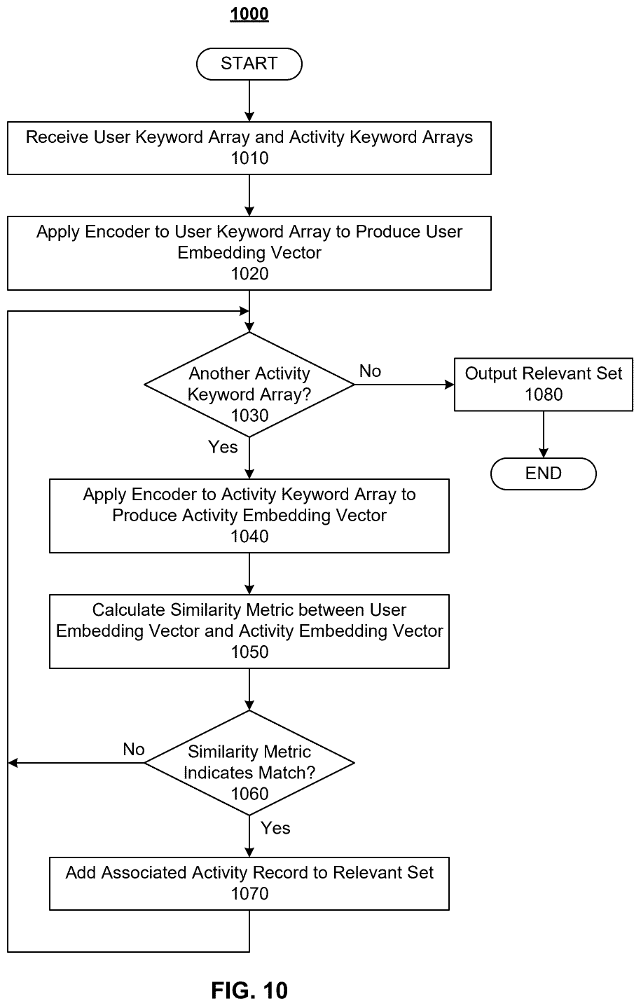

FIG. 10 illustrates a process 1000 for contextual keyword matching, according to an embodiment. Process 1000 may be implemented by contextual-keyword-matching module 340 of server application 112, to operate on an input comprising user keyword array 335 and a plurality of activity keyword arrays 325.

While process 1000 is illustrated with a certain arrangement and ordering of subprocesses, process 1000 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Initially, subprocess 1010 may receive user keyword array 335 and a plurality of activity keyword arrays 325. Each of user keyword array 335 and the plurality of activity keyword arrays 325 may comprise a plurality of keywords, and each keyword may comprise one or a plurality of tokens. In addition, each of the plurality of activity keyword arrays may be associated with an activity record 315 comprising a URL and an IP address, and potentially other information, such as a timestamp.

Subprocess 1020 may apply encoder 700 to user keyword array 335 to produce user embedding vector 825A. As discussed elsewhere herein, encoder 700 may comprise one or more phrase-localized attention layers 610 (e.g., three phrase-localized attention layers 610A-610C), and each phrase-localized attention layer 610 may comprise a phrase-localized attention network 620 for each of the plurality of keywords in user keyword array 335. Thus, for example, if user keyword array 335 consists of N keywords, each phrase-localized attention layer 610 will consist of N phrase-localized attention networks 620. Encoder 700 may also comprise one or more scaled dot-product attention layers 510, subsequent to the phrase-localized attention layer(s) 610, as discussed elsewhere herein.

Subprocess 1030 may determine whether or not another one of the plurality of activity keyword arrays 325 remains to be considered. When another activity keyword array 325 remains to be considered (i.e., “Yes” in subprocess 1030), process 1000 may select the next activity keyword array 325 from the plurality of activity keyword arrays 325, and proceed to subprocess 1040. Thus, subprocesses 1040-1060 are performed for each of the plurality of activity keyword arrays 325, and subprocess 1070 is typically performed for a subset of the plurality of activity keyword arrays 325. When no more activity keyword arrays 325 remain to be considered (i.e., “No” in subprocess 1030), process 1000 may proceed to subprocess 1080.

Subprocess 1040 may apply encoder 700 to the selected activity keyword array 325 to produce an activity embedding vector 825B. Encoder 700 may be the same encoder as was applied to user keyword array 335 in subprocess 1020. However, it should be understood that each phrase-localized attention layer 610 in encoder 700 may be adjusted as needed, such that the number of phrase-localized attention networks 620 correspond to the number of keywords in the selected activity keyword array 325. For example, the number of phrase-localized attention networks 620 may be increased or decreased from a previous application of encoder 700 to match the number of keywords in the selected activity keyword array 325. Thus, each phrase-localized attention layers 610 in encoder 700 will comprise one phrase-localized attention network 620 for each of the plurality of keywords in the currently selected activity keyword array 325.

Subprocess 1050 may calculate similarity metric 915 between user embedding vector 825A and the selected activity embedding vector 825B. Subprocess 1040 may be implemented by similarity-calculation module 910, as described elsewhere herein. In an embodiment, similarity metric 915 comprises or consists of the cosine similarity between user embedding vector 825A and the selected activity embedding vector 825B.

Subprocess 1060 may determine whether or not similarity metric 915 indicates a match between user embedding vector 825A and activity embedding vector 825B, and thereby a match between user keyword array 335 and the selected activity keyword array 325, based on one or more criteria. For example, the one or more criteria may comprise or consist of the value of similarity metric 915 being equal to or greater than a predefined threshold (e.g., representing a boundary between similar and dissimilar). Alternatively, in the event that similarity metric 915 represents the distance between user embedding vector 825A and activity embedding vector 825B, the one or more criteria may comprise or consist of the value of similarity metric 915 being less than or equal to a predefined threshold (e.g., representing a maximum distance for similarity). In either case, the predefined threshold may be defined in any suitable manner. It should be understood that these are just examples, and that the one or more criteria that define whether or not similarity metric 915 indicates a match between user embedding vector 825A and activity embedding vector 825B may comprise or consist of any other suitable criterion. When determining that similarity metric 915 indicates a match between user embedding vector 825A and activity embedding vector 825B (i.e., “Yes” in subprocess 1060), process 1000 may proceed to subprocess 1070. Otherwise, when determining that similarity metric 915 does not indicate a match between user embedding vector 825A and activity embedding vector 825B (i.e., “No” in subprocess 1060), process 1000 may return to subprocess 1030.

Subprocess 1070 may add the activity record 315, associated with the matching activity keyword array 325, to a relevant set of activity records 315. In particular, subprocess 1060 may retrieve the activity record 315 that is associated with the matching activity keyword array 325, as determined in subprocess 1050, and add that activity record 315 to a relevant set of activity records 315 that is maintained throughout process 1000. It should be understood that activity record 315 refers to any representation of a URL and IP address, and potentially other information (e.g., a timestamp).

Subprocess 1080 may output the relevant set of activity records 315 to a downstream function, such as intent-identification module 350. Notably, activity records 315 associated with any activity keyword arrays 325, that are not determined to match the user keyword array 335 in subprocess 1060, will not be added to this relevant set of activity records. Thus, the relevant set of activity records 315 will only contain activity records 315 for those online activities that are relevant to the user's business. Here, relevance is defined as the activity keyword array 325, derived from activity record 315, having a sufficiently similar context (e.g., as defined by a similarity metric 915 indicating a match) to a user keyword array 335 that represents the user's business.

In an embodiment, prior to outputting the relevant set of activity records 315, subprocess 1080 may filter the relevant set of activity records 315. For example, the relevant set of activity records 315 may be limited to a maximum number or percentage of activity records 315. In this case, the activity records 315 in the relevant set of activity records 315 may be ranked according to similarity metric 915, and activity records 315 ranked below the cut-off (e.g., top number or percentage) may be removed from the relevant set of activity records 315.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive a user keyword array and a plurality of activity keyword arrays, wherein each of the user keyword array and the plurality of activity keyword arrays comprises a plurality of keywords, wherein each keyword comprise one or a plurality of tokens, and wherein each of the plurality of activity keyword arrays is associated with an activity record comprising a Uniform Resource Locator (URL) and an Internet Protocol (IP) address;
apply an encoder to the user keyword array to produce a user embedding vector, wherein the encoder comprises one or more phrase-localized attention layers, and wherein each of the one or more phrase-localized attention layers comprises one phrase-localized attention network for each of the plurality of keywords in the user keyword array;
for each of the plurality of activity keyword arrays,
apply the encoder to the activity keyword array to produce an activity embedding vector, wherein each of the one or more phrase-localized attention layers comprises one phrase-localized attention network for each of the plurality of keywords in the activity keyword array,
calculate a similarity metric between the user embedding vector and the activity embedding vector, and
when the similarity metric indicates a match between the user embedding vector and the activity embedding vector, add the activity record that is associated with the activity embedding vector to a relevant set of activity records; and
output the relevant set of activity records to one or more downstream functions.

2. The method of claim 1, wherein the one or more phrase-localized attention layers are at least three phrase-localized attention layers.

3. The method of claim 1, wherein the one or more phrase-localized attention layers consist of three phrase-localized attention layers.

4. The method of claim 1, wherein the encoder further comprises one or more scaled dot-product attention layers.

5. The method of claim 3, wherein the one or more scaled dot-product attention layers are subsequent to the one or more phrase-localized attention layers.

6. The method of claim 4, wherein the one or more scaled dot-product attention layers are at least three scaled dot-product attention layers.

7. The method of claim 4, wherein the one or more scaled dot-product attention layers consist of three scaled dot-product attention layers.

8. The method of claim 1, wherein the encoder comprises at least three phrase-localized attention layers, followed by at least three scaled dot-product attention layers.

9. The method of claim 8, wherein each phrase-localized attention network and each of the at least three scaled dot-product attention layers utilize multi-head attention.

10. The method of claim 9, wherein the encoder utilizes keyword-level positional encoding to encode a position of each token within each of the plurality of keywords.

11. The method of claim 1, wherein each phrase-localized attention network utilizes multi-head attention.

12. The method of claim 1, wherein the encoder utilizes keyword-level positional encoding to encode a position of each token within each of the plurality of keywords.

13. The method of claim 1, wherein the encoder consists of three phrase-localized attention layers, followed by three scaled dot-product attention layers.

14. The method of claim 1, further comprising using the at least one hardware processor to, prior to applying the encoder, train a transformer network comprising the encoder and a decoder, wherein the encoder receives a keyword array from a training dataset as an input and outputs an embedding vector, and wherein the decoder receives the embedding vector, output by the encoder, as an input and outputs a predicted keyword.

15. The method of claim 14, further comprising using the at least one hardware processor to, prior to training the transformer network, generate the training dataset by:
receiving a plurality of keyword arrays; and
for each of the plurality of keyword arrays, for each of one or more iterations,
selecting one keyword from the keyword array,
generating an input consisting of all keywords in the keyword array except for selected keyword,
labeling the input with a target consisting of the selected keyword, and
adding the labeled input to the training dataset.

16. The method of claim 15, wherein training the transformer network comprises, for each of at least a subset of the labeled inputs in the training dataset:
applying the transformer network to the input in the labeled input to produce the predicted keyword for the input;
computing a loss between the target, with which the input is labeled, and the predicted keyword; and
updating the transformer network to minimize the computed loss.

17. The method of claim 1, wherein the similarity metric comprises a cosine similarity between the user embedding vector and the activity embedding vector.

18. The method of claim 1, wherein the one or more downstream functions comprise a predictive model that predicts a buying intent of at least one company, associated with at least one IP address in the relevant set of activity records, based on the relevant set of activity records.

19. A system comprising:
at least one hardware processor; and
software that is configured to, when executed by the at least one hardware processor,
receive a user keyword array and a plurality of activity keyword arrays, wherein each of the user keyword array and the plurality of activity keyword arrays comprises a plurality of keywords, wherein each keyword comprise one or a plurality of tokens, and wherein each of the plurality of activity keyword arrays is associated with an activity record comprising a Uniform Resource Locator (URL) and an Internet Protocol (IP) address,
apply an encoder to the user keyword array to produce a user embedding vector, wherein the encoder comprises one or more phrase-localized attention layers, and wherein each of the one or more phrase-localized attention layers comprises one phrase-localized attention network for each of the plurality of keywords in the user keyword array,
for each of the plurality of activity keyword arrays,
apply the encoder to the activity keyword array to produce an activity embedding vector, wherein each of the one or more phrase-localized attention layers comprises one phrase-localized attention network for each of the plurality of keywords in the activity keyword array,
calculate a similarity metric between the user embedding vector and the activity embedding vector, and
when the similarity metric indicates a match between the user embedding vector and the activity embedding vector, add the activity record that is associated with the activity embedding vector to a relevant set of activity records, and output the relevant set of activity records to one or more downstream functions.

20. A non-transitory computer-readable medium having instructions stored therein, wherein the instructions, when executed by a processor, cause the processor to:
receive a user keyword array and a plurality of activity keyword arrays, wherein each of the user keyword array and the plurality of activity keyword arrays comprises a plurality of keywords, wherein each keyword comprise one or a plurality of tokens, and wherein each of the plurality of activity keyword arrays is associated with an activity record comprising a Uniform Resource Locator (URL) and an Internet Protocol (IP) address;
apply an encoder to the user keyword array to produce a user embedding vector, wherein the encoder comprises one or more phrase-localized attention layers, and wherein each of the one or more phrase-localized attention layers comprises one phrase-localized attention network for each of the plurality of keywords in the user keyword array;
for each of the plurality of activity keyword arrays,
apply the encoder to the activity keyword array to produce an activity embedding vector, wherein each of the one or more phrase-localized attention layers comprises one phrase-localized attention network for each of the plurality of keywords in the activity keyword array,
calculate a similarity metric between the user embedding vector and the activity embedding vector,
when the similarity metric indicates a match between the user embedding vector and the activity embedding vector, add the activity record that is associated with the activity embedding vector to a relevant set of activity records; and
output the relevant set of activity records to one or more downstream functions.
